(19) United States
(12) Patent Application Publication
(10) Pub. No.: US 2024/0237845 A1
(43) Pub. Date: Jul. 18, 2024

(54) INTELLIGENT HOT BEVERAGE MAKER

(71) Applicant: UNIVERSAL BRAND GROUP (PTY) LIMITED, Johannesburg (ZA)

(72) Inventors: Ho Hiu WAI, Hong Kong (HK); Lui Wing KIT, Hong Kong (HK)

(21) Appl. No.: 18/561,828

(22) PCT Filed: Mar. 9, 2022
(86) PCT No.: PCT/ZA2022/050011

§ 371 Date: Nov. 17, 2023

(30) Foreign Application Priority Data
May 18, 2021 (ZA) 2021/03333

(51) Int. Cl. A47J 31/36; A47J 31/44; A47J 31/52; G07F 13/06

(52) U.S. Cl. CPC A47J 31/3642; A47J 31/3633; A47J 31/4421; A47J 31/4435; A47J 31/4492; A47J 31/521; A47J 31/525; G07F 13/065

(57) ABSTRACT

An intelligent hot beverage maker is provided including: a beverage machine; a series of mutually stacked magazines, for the storage of multiple beverage pods, the magazine being dimensioned and configured to fasten releasably to the beverage machine; a slot, through which a pod passes from the magazine into the beverage machine; an actuator, for forcing a pod through the slot selectively; selection means, for selecting between beverages on a given menu; and identification means, for identifying which pod in the magazine is appropriate for a given beverage selection; and intelligent software for controlling the operation of the maker, wherein selection means may be manipulated remotely, and by multiple users simultaneously.

### CROSS-REFERENCE TO RELATED APPLICATIONS

This application claims priority to PCT Application No. PCT/ZA2022/050011, having a filing date of Mar. 9, 2022, based on South African Application No. 2021/03333, having a filing date of May 18, 2021, the entire contents both of which are hereby incorporated by reference.

### FIELD OF TECHNOLOGY

The following relates, broadly, to an intelligent hot beverage maker. More particularly, but not exclusively, the following has application to an intelligent coffee machine.

### BACKGROUND

The availability of smart coffee machines is reasonably well-known in the conventional art in recent times. For example: the Behmor™ Connected coffee machine boasts the following functionalities: customised temperature control capability and the remote-brewing and scheduled-brewing functionality. Furthermore, both the Atomi™ Smart Coffee Maker and the Nespresso™ Expert (coffee pod) Coffee Machine have the following capabilities: both are capable of voice-operation via Alexa or via the Google Assistant: both permit remote operation via a cell phone, and both offer a scheduled programming function to commence coffee-brewing at a set time.

Convenient as these functionalities may be, the conventional art suffers from a number of shortcomings. For example: each of these machines offers only a single type of beverage—for example: the Behmor™ and Atomi™ units mentioned above are exclusively coffee-bean percolating machines, while the Nespresso™ Expert unit is exclusively a coffee pod machine, that is capable of handling a single, pre-loaded pod only. So, for example, there is no way to use any of these machines for more than one brewing, nor more than one type of beverage (eg: cappuccino, Americano, etc). This is regarded as significantly disadvantageous.

It will also be appreciated that each of these conventional art units is capable of being used by a single user only at any given time—this is regarded as being a further limitation.

### SUMMARY

An aspect relates to an intelligent hot beverage maker, that will overcome, at least partially, the disadvantages described above.

According to embodiments of the invention, there is provided an intelligent hot beverage maker, the maker comprising:
a beverage machine;
at least one magazine, for the storage of multiple beverage pods, the magazine being dimensioned and configured to fasten releasably to the beverage machine;
a slot, through which a pod passes from the magazine into the beverage machine;
an actuator, for forcing a pod through the slot selectively;
selection means, for selecting between beverages on a given menu; and
identification means, for identifying which pod in the magazine is appropriate for a given beverage selection,
characterised in that selection means may be manipulated remotely, and by multiple users simultaneously.

In an embodiment, each magazine is substantially carousel shaped, comprising a series of spaced-apart pod holding formations. In an embodiment of the invention, the series of pod holding formations are regularly spaced.

The identification means comprises:
a unique visual indicator, located on each pod, for identifying uniquely the contents of each pod;
a reader for reading and interpreting the visual indicator; and intelligent software for directing the actuator to force a designated pod only through the slot to match a particular beverage selection.

The visual indicator may be selected from the group consisting of: a QR code, a bar code, a unique colour, a unique pattern, a unique visual signature and a combination of these. The reader may then be a corresponding reader capable of reading the particular visual indicator.

The actuator may comprise:
a motor, for swivelling the magazine about a fixed point;
at least one rod, for urging pods selectively into the beverage machine, each rod associated uniquely with an associated pod; and with each rod between movable selectively between a deployed position. in which free motion of the magazine is permitted, and a retracted position, in which the selected pod is compelled to pass through the slot; and
intelligent software for determining the appropriate timing for the actuation of the push rod into the stowed position.

The holding formation may be dimensioned and configured to receive the rim of a pod, at least partially within it.

In an embodiment, the holding formation and the slot have the same shape.

In an embodiment of the invention, the maker includes a series of at least two magazines, the magazines arranged in a mutually stacked formation.

In an embodiment, operation of the actuator to compel the selected pod to pass through the slot further results in the corresponding pod in the superjacent magazine falls under gravity to replace the selected pod.

The intelligent software may take the form of firmware incorporated into the maker.

The motor may be selected from the group consisting of: a stepper motor, a dc motor, a servo motor, and a synchronous motor.

The maker may further comprise a flow-divider, for directing the flow of beverage from the machine.

The maker may further comprise:
a series of cup holders, for the advance placement of cups: and
a sensor for sensing the presence or absence of a cup in any given cup holder.

The maker may further include intelligent software for determining the direction of flow of the beverage exclusively towards those cup holders which are occupied by a cup.

In an embodiment of the invention, a user may select a particular cup holder into which the selected beverage is to be permitted to flow.

The maker may further select a series of cup warming mats, with each mat being associated with a unique cup holder.

The maker may further include intelligent software for activating the cup warming mats selectively.

The maker may further include intelligent software for controlling the temperature and duration of heating of the warming mats.

The maker may be connectable to the internet.

The maker may be voice operable, through application of a virtual assistant tool.

The pod may include within it a beverage selected from the group consisting of: coffee, tea, herbal infusion, chocolate preparation, confectionery preparation, flavoured beverage preparation, and a combination of these.

### BRIEF DESCRIPTION

Some of the embodiments will be described in detail, with references to the following Figures, wherein like designations denote like members, wherein:

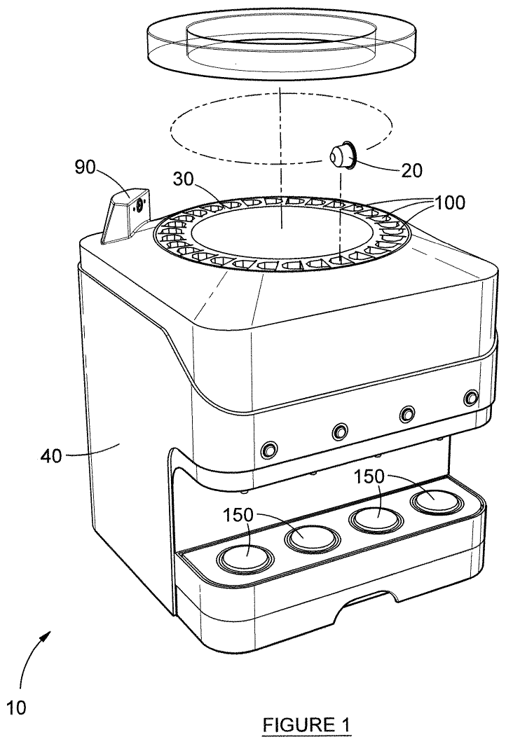

FIG. 1 is an isometric, partially exploded view from above of the intelligent hot beverage maker in accordance with embodiments of the invention, emphasising the magazine;

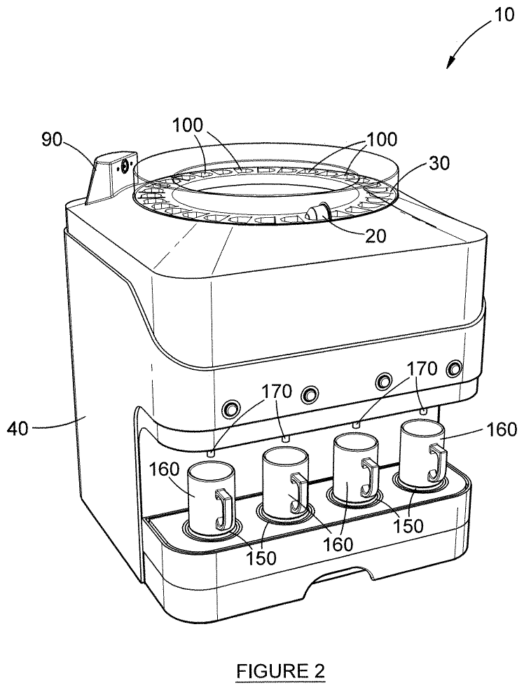

FIG. 2 is an isometric, partially exploded view from above of the intelligent hot beverage maker shown in FIG. 1, with a series of cups pre-assembled for use;

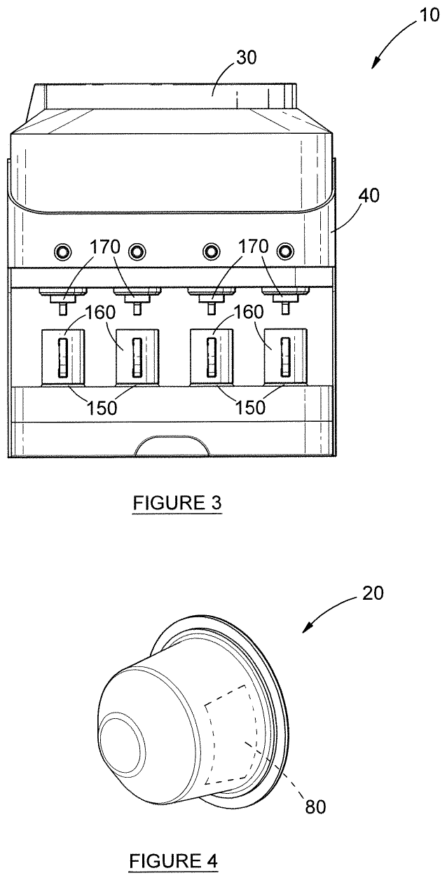

FIG. 3 is a front view from above of the intelligent hot beverage maker depicted in FIG. 2;

FIG. 4 is an isometric view from above of a typical pod used in the operation of embodiments of the invention;

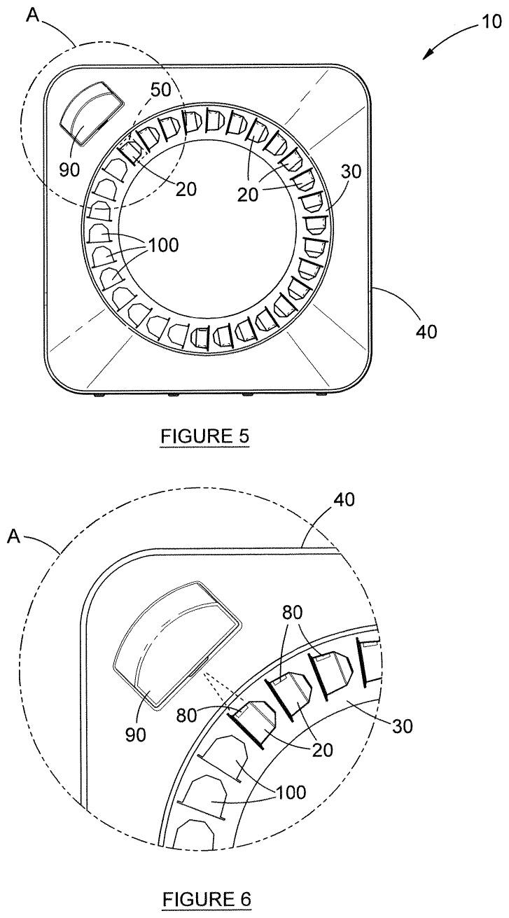

FIG. 5 is a plan view from above of the intelligent hot beverage maker, with a fully-loaded magazine of pods;

FIG. 6 is an enlarged depiction of the area depicted within circle “A” in FIG. 5;

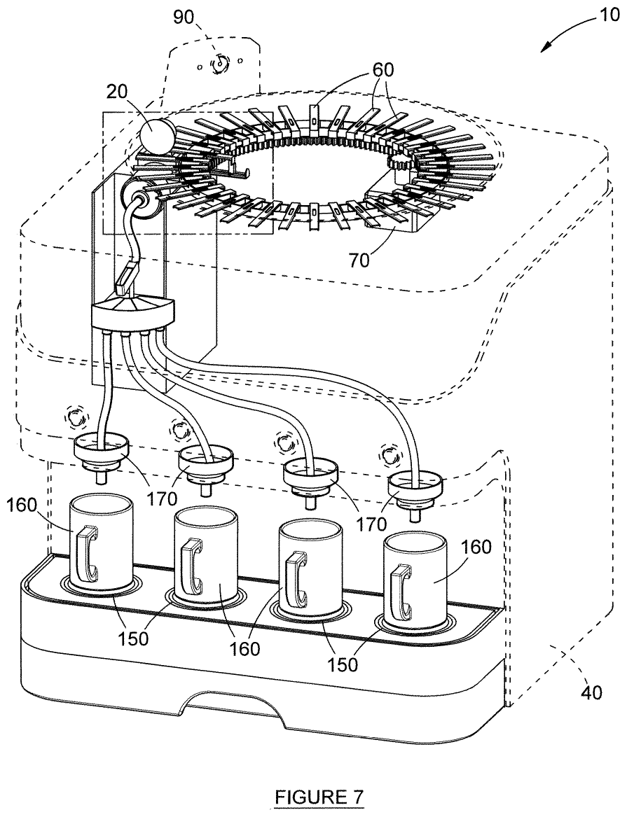

FIG. 7 is a partial cutaway of the image depicted in FIG. 2;

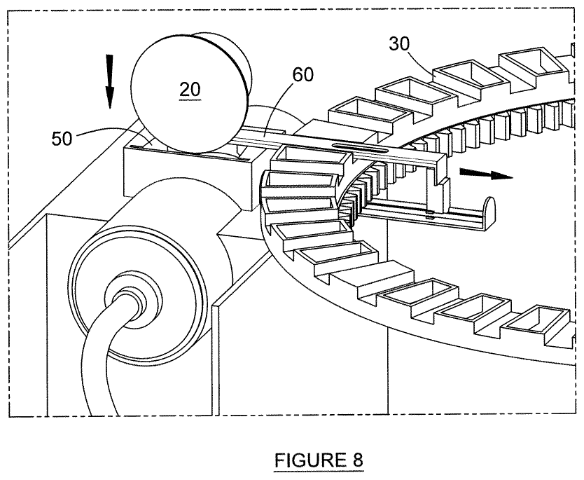

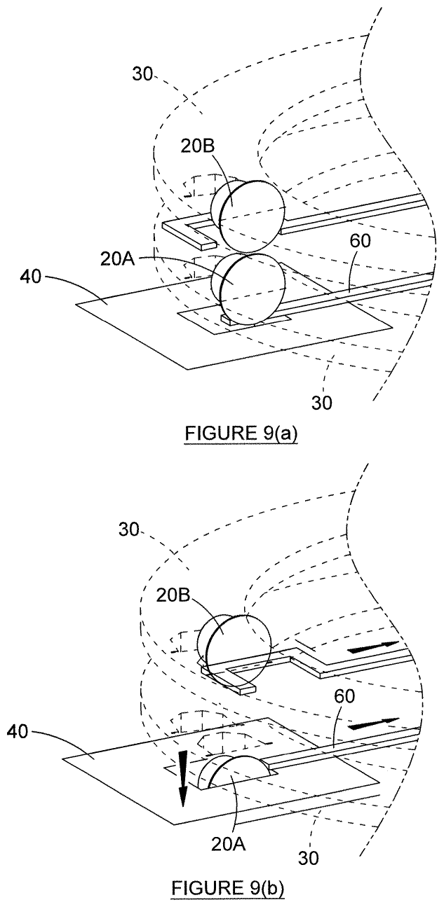

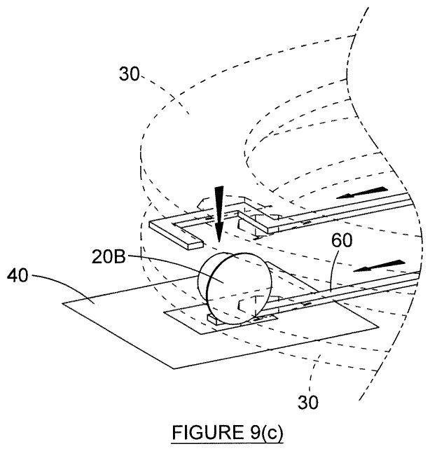

FIG. 8 is a close-up of part of embodiments of the invention, emphasising the cooperation of the magazine, actuator and slot in use;

FIG. 9a is an isometric view from above of the intelligent hot beverage maker in accordance with embodiments of the invention, wherein a multi-layered stacked series of magazines is employed;

FIG. 9b is an isometric view from above of the intelligent hot beverage maker in accordance with embodiments of the invention, wherein a multi-layered stacked series of magazines is employed;

FIG. 9c is an isometric view from above of the intelligent hot beverage maker in accordance with embodiments of the invention, wherein a multi-layered stacked series of magazines is employed; and

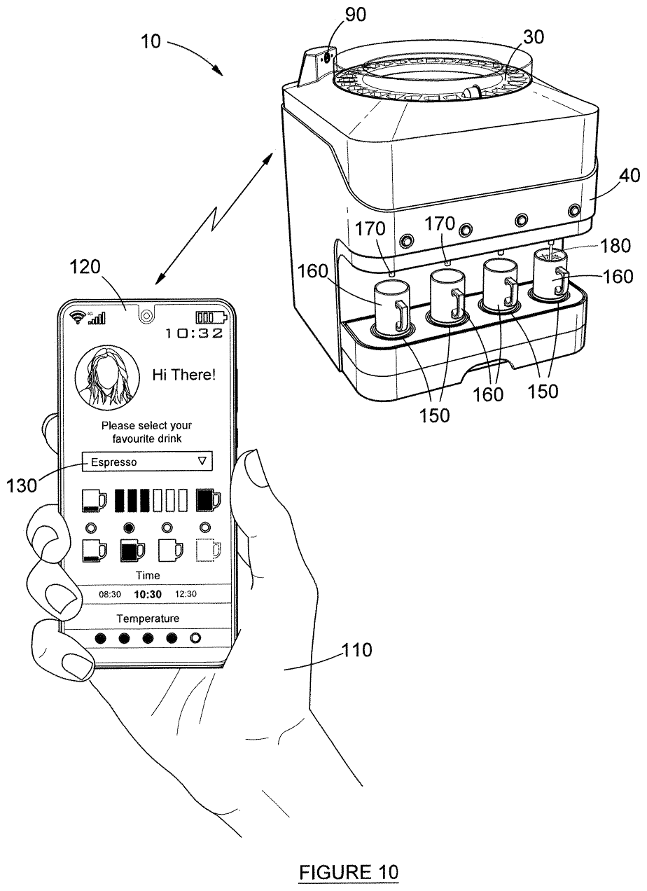

FIG. 10 is a diagrammatic representation of embodiments of the invention in use by a user remotely.

### DETAILED DESCRIPTION

Referring to the figures, which depict an embodiment of the invention, an intelligent hot beverage maker in accordance with embodiments of the invention is provided, and is referred to generally by numeral 10. Embodiments of the invention are described in the context of a coffee machine 20. However, and as will be appreciated readily by an expert in the field, embodiments of the invention has application, equally, to any other beverage machine in which the beverage is pre-packaged in pods 20—this includes: teas, herbal infusions, chocolate-based beverages, flavoured beverages, and the like. The maker 10 comprises: a magazine 30, which stores multiple beverage-containing pods 20, and a conventional coffee machine 40, to which magazine 30 is readily fastened releasably—in the example illustrated in the accompanying figures, this is achieved in a friction-fit arrangement. The coffee machine 40 depicted is a Beare CDS-1 model coffee machine. Naturally, and as will be appreciated by the expert in the field, countless possibilities of alternative, equivalent coffee machines exist.

The maker 10 further comprises a slot 50 (best illustrated in FIG. 6) through which a pod 20 passes from the magazine 30 into the coffee machine 40 on operation (in the fashion described below). The maker 10 also includes an actuator, which takes the form of the combination of: a series of rods 60, stepper motor 70 and intelligent firmware that is preloaded onto the maker 10. It is stressed that, in an embodiment of the invention, a single rod 60 is used, and a series of multiple rods 60 is not strictly necessary. In an embodiment, the magazine 30 is substantially carousel shaped, and comprising a series of spaced-apart pod-holding-formations 100. In an embodiment of the invention, and as is illustrated in the accompanying figures, the series of pod-holding-formations 100 are regularly spaced. It will also be noted that the slot 50 and each of the series of pod-holding-formations 100 are identically shaped and dimensioned, so as to receive and accommodate a pod 20 perfectly within it.

The motor 70 depicted here is a stepper motor. In an of the invention, the magazine 30 is a perfect circle, which has been found to provide optimal performance. The motion of the stepper motor 70 permits the magazine 30 to swivel about its centre, which is a fixed point. Each of the series of rods 60 is serves the purpose of urging a pod 20 selectively into the beverage machine 40 selectively. More specifically, each rod 60 is associated uniquely with an associated pod 20. In use, each rod 60 in movable between a deployed position. in which free motion of the magazine 30 is permitted, and a stowed position, in which the selected pod 20 is compelled to pass through the slot 50. This is best illustrated in FIGS. 9a, 9b and 9c, where the direction of motion of the pod 20 into the beverage maker 40 is indicated by the arrow. In ordinary use of the beverage maker 40, each of the series of rods 60 is biased towards the deployed position, in which each rod 60 extends to its maximum length. It will be noted that each rod 60 extends directly below its associated pod-holding-formation 100 (when in the deployed position). In this way, any pod 20 accommodated in the pod-holding-formation 100 is held trapped in it. The final component of the actuator is the intelligent software, which takes the form of firmware, preloaded onto a microchip (not depicted) in the beverage maker 40. That software determines, amongst other things, the appropriate timing for the actuation of the rod into the deployed position.

In embodiments of the invention (not depicted), the motor 70 is specifically envisaged to be a dc motor, a servo motor, or a synchronous motor: it need not necessarily be a stepper motor exclusively.

Before explaining further operation of the actuator, it is necessary to describe the identification means, which comprises a unique visual indicator 80, located on each pod 20, for identifying uniquely the contents of each pod 20. In an embodiment, the visual indicator 80 takes the form of a QR code. However, it will be appreciated by the expert in the field that, in other embodiments of the invention (not depicted), the visual indicator 80 would take the form of a bar code, a unique colour, a unique pattern, a unique visual signature, and a combination of these. The identification means further includes a reader 90 which compliments the particular selection of visual indicator 80—so, for example, in an embodiment of the invention in which the visual indicator 80 is a QR code, the reader 90 is a QR reader may then be a corresponding reader capable of reading the particular visual indicator. Conversely, in an embodiment of the invention (not depicted) in which the visual indicator 80 is a bar code, the reader 90 is a bar code reader. The purpose of the visual indicator 80 is to indicate the contents of the pod 20 to which it is affixed—so, for example: certain pods 20 will contain a hazelnut infused coffee grind, whereas other pods 20 will contain a roasted Ethiopian coffee bean, etc. For reasons that will be explained below, the reader 90 is positioned on the beverage maker 40 when the relevant pod 20 is located directly above the slot 50.

In an embodiment of the invention (not depicted) the reader 90 is a set of two cameras, which are programmed to recognise patterns and colour signature of the pods 20. Those patterns and colour signatures are stored in the cloud and that data is referenced to determine the content identity of each pod as it is scanned. Communication of such data is pushed to the user's 110 cellphone 120, and accessed via the menu 130, which is described in further detail below.

The operation of the machine by users will now be explained. In one method of operation, a user 110 will use her cellphone 120 to access a menu 130 of beverages on offer in the beverage maker 40. Naturally, that menu 130 is dependent on the content of the selection of pods 20 preloaded into the magazine 30 at any given time. Fortunately, with the benefit of a web-based application, the menu 130 is capable of being updated as frequently as required. The user 110 enters her selection, which is conveyed to the beverage maker 40 via an internet connection (not depicted). In an embodiment of the invention (not depicted): when users are in sufficiently close proximity to the beverage maker 40, the user 110's selection is communicated to the beverage maker 40 via a Bluetooth™ connection between the cellphone 120 and the beverage maker 40. In an embodiment of the invention (not depicted) a user 110 will indicate her desired beverage via the voice-activated application of a virtual assistant tool, such as Alexa—the user 110 would simply say out loud “Hey Alexa™, please make me a mocha latte”, and that election would then be communicated from the Alexa™ device to the beverage maker 40 in the ordinary fashion.

So, for example: when the user 110 selects a hazelnut-coffee beverage, that message is received on the computing device (not depicted) in the beverage maker 40, in which the intelligent software (firmware) is embedded. That directs the stepper motor 70 to commence its iterative operation, causing each pod 20, in turn, to have its associated visual indicator 80 to be exposed to the reader 90. That iterative movement will continue until such time as the reader 90 identifies that the particular pod 20 before it contains the hazelnut coffee beverage for brewing. That, in turn, causes the firmware to direct a further operation in which the rod 60 associated uniquely with that pod 20 is pulled against the direction of its natural bias (in the stowed condition), towards the deployed position, in which the rod 60 is retracted towards the centre of the magazine 30, exposing the pod 20 to the slot 50, through which the pod 20 then falls, into the beverage maker 40. At that point, the contents of the selected pod 20 are then brewed in the ordinary operation of the beverage maker 40.

In an embodiment of the invention, the maker 10 incorporates a series of magazines 30, which are stowed in a stacked formation. This is best illustrated in FIGS. 9a, 9b and 9c, which show a series of two concentric magazines 30 in stacked formation. More specifically, FIGS. 9(a) to 9(c) show how, when rod 60 is retracted and selected pod 20A then falls into the beverage maker 40, the position of that selected pod 20A is replaced by the pod 20B immediately above it in the superjacent magazine 30, which similarly falls under gravity into that position.

As is best depicted in FIG. 7: the beverage maker 40 further comprise a flow-divider 140, proximate the beverage nozzles 170, for directing the flow of beverage 180 from the beverage maker 40 into designated cups 160. It also comprises a series of cup holders 150, for the advance placement of cups 160. So, for example, a user 110 will select on menu 130 that her beverage is to be directed to flow into the cup 160 in the third position from the left. That, too, is regulated by the intelligent software. In an embodiment of the invention (not depicted), each cup holder includes a sensor, for sensing the presence or absence of a cup 160 in any given cup holder 150—and the intelligent software will not permit the directing of beverage 180 into any position on the beverage maker 40 that does not have a cup 160 installed to receive it. In an embodiment of the invention, the intelligent software is pre-programmed always to direct the flow of a unique user 110 to the same position. It will be appreciated that this is convenient in a household setting or office setting, where multiple users 110 use the same maker 10 to prepare their desired beverage.

The beverage maker 40 further select a series of cup warming mats (not depicted), located within each cup holder 150, for heating a cup 160 prior to and/or after receiving the flow of beverage 180 therein.

It will also be appreciated by the expert in the field that the intelligent software on the beverage maker 40 is programmable selectively by a user 110. So, for example, a user 110 will manipulate menu 130 to select a chai latte, but that its brewing is to be delayed until 07:30 the next morning.

Furthermore, in an embodiment of the invention, menu 130 includes an option to combine more than one pod 20 in a single brewing sequence, thereby making a unique and mixed beverage.

Furthermore, and in a distinct advantage achieved by embodiments of the invention, it will be appreciated immediately how up to four discreet users 110 will be able to place their own orders, for their own (different) choice of beverage, where each user 110 uses their own cell phone 120, or virtual assist, as the respective users 110 please. And each of the four selected beverages 180 will be prepared sequentially, on the same beverage maker 40.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1-23. (canceled)

24. An intelligent hot beverage maker, the maker comprising:
a beverage machine;
at least one magazine, for the storage of multiple beverage pods, the magazine being dimensioned and configured to fasten releasably to the beverage machine;
a slot, through which a pod passes from the magazine into the beverage machine;
an actuator, for forcing a pod through the slot selectively, the actuator comprising a motor, for swivelling the magazine about a fixed point,
at least one rod, for urging pods selectively into the beverage machine, each rod associated uniquely with an associated pod; and with each rod between movable selectively between a deployed position, in which free motion of the magazine is permitted, and a retracted position, in which the selected pod is compelled to pass through the slot, and intelligent software for determining the appropriate timing for the actuation of the push rod into the stowed position selection means, for selecting between beverages on a given menu; and
identification means, for identifying which pod in the magazine is appropriate for a given beverage selection, wherein selection means may be manipulated remotely, and by multiple users simultaneously.

25. The beverage maker according to claim 24, wherein each magazine is substantially carousel shaped, comprising a series of spaced-apart pod holding formations.

26. The beverage maker according to claim 24, wherein the series of pod holding formations are regularly spaced.

27. The beverage maker according to claim 24, wherein the identification means comprises:
a unique visual indicator, located on each pod, for identifying uniquely the contents of each pod;
a reader for reading and interpreting the visual indicator; and
intelligent software for directing the actuator to force a designated pod only through the slot to match a particular beverage selection.

28. The beverage maker according to claim 24, wherein the visual indicator is selected from the group consisting of: a QR code, a bar code, a unique color, a unique pattern, a unique visual signature and a combination of these.

29. The beverage maker according to claim 28, wherein the reader is a corresponding reader capable of reading the particular visual indicator.

30. The beverage maker according to claim 24, wherein the holding formation is dimensioned and configured to receive the rim of a pod, at least partially within it.

31. The beverage maker according to claim 25, wherein the holding formation and the slot have the same shape.

32. The beverage maker according to claim 24, which includes a series of at least two magazines, the magazines arranged in a mutually stacked formation.

33. The beverage maker according to claim 32, wherein the operation of the actuator to compel the selected pod to pass through the slot further results in the corresponding pod in the superjacent magazine falls under gravity to replace the selected pod.

34. The beverage maker according to claim 27, wherein the intelligent software takes the form of firmware incorporated into the maker.

35. The beverage maker according to claim 24, wherein the motor is selected from the group consisting of: a stepper motor, a dc motor, a servo motor, and a synchronous motor.

36. The beverage maker according to claim 24, which further comprises a flow-divider, for directing the flow of beverage from the machine.

37. The beverage maker according to claim 24, which further comprises:
a series of cup holders, for the advance placement of cups; and
a sensor for sensing the presence or absence of a cup in any given cup holder.

38. The beverage maker according to claim 37, which further includes intelligent software for determining the direction of flow of the beverage exclusively towards those cup holders which are occupied by a cup.

39. The beverage maker according to claim 37, wherein a user selects a particular cup holder into which the selected beverage is to be permitted to flow.

40. The beverage maker according to claim 24, which further includes a series of cup warming mats, with each mat being associated with a unique cup holder.

41. The beverage maker according to claim 40, which further includes intelligent software for activating the cup warming mats selectively.

42. The beverage maker according to claim 40, which further includes intelligent software for controlling the temperature and duration of heating of the warming mats

43. The beverage maker according to claim 24, which is connectable to the internet.

44. The beverage maker according to claim 24, which is voice operable, through application of a virtual assistant tool.

45. The beverage maker according to claim 24, wherein the pod includes within it a beverage selected from the group consisting of: coffee, tea, herbal infusion, chocolate preparation, confectionery preparation, flavoured beverage preparation, and a combination of these.
